(19) United States
(12) Patent Application Publication
(10) Pub. No.: US 2025/0341123 A1
(43) Pub. Date: Nov. 6, 2025

(54) FITTING FOR MOVABLY SUPPORTING A PIVOTING ELEMENT

(71) Applicant: Julius Blum GmbH, Hoechst (AT)

(72) Inventor: Andreas Holzapfel, Bregenz (AT)

(21) Appl. No.: 19/269,481

(22) Filed: Jul. 15, 2025

Related U.S. Application Data
(63) Continuation of application No. PCT/AT2023/060398, filed on Nov. 17, 2023.

(30) Foreign Application Priority Data
Jan. 31, 2023 (AT) A 50056/2023

(51) Int. Cl. E05D 5/02; E05D 7/04

(52) U.S. Cl. CPC E05D 5/0276; E05D 7/0415; E05D 2007/0476

(57) ABSTRACT

A fitting for movably supporting a pivoting element relative to a stationary structure includes a first fitting portion to be fixed to the stationary structure, with the first fitting portion to be at least partially inserted into a recess in the stationary structure, a second fitting portion to be fixed to a pivoting element, and a hinge axis pivotally connecting the first fitting portion and the second fitting portion to each other. The first fitting portion includes a housing having a front face facing towards the second fitting portion, and a housing side extending transversely to the front face. An arm is provided on which the hinge axis is arranged, and the arm projects transversely from the housing side of the first fitting portion.

The present application is a continuation of International Application PCT/AT2023/060398 filed on Nov. 17, 2023. Thus, all of the subject matter of International Application PCT/AT2023/060398 is incorporated herein by reference.

### BACKGROUND OF THE INVENTION

The present invention relates to a fitting, configured as a furniture fitting or as a construction fitting, for movably supporting a pivoting element relative to a stationary structure, in particular a furniture carcass. The fitting comprises a first fitting portion to be fixed to the stationary structure, the first fitting portion being configured to be at least partially inserted into a recess in the stationary structure, a second fitting portion to be fixed to a pivoting element, in particular to a movable furniture part, and at least one hinge axis pivotally connecting the first fitting portion and the second fitting portion to each other.

Moreover, the invention relates to an arrangement comprising a stationary structure, in particular a furniture carcass, and at least one fitting of the type to be described.

WO 2020/006589 A1 discloses a furniture fitting having two fitting portions hingedly connected to each other for the movable support of a furniture door. A first fitting portion is configured to be countersunk within a sidewall of a furniture carcass. Therefore, the first fitting portion of the furniture fitting can be integrated into the sidewall in a very compact manner, and an arm of the fitting portion is guided through a front-sided recess of the sidewall. However, this type of furniture fitting can only be used for limited applications. Difficulties may arise when the furniture carcass bears directly against a room wall or directly against an adjacent furniture carcass. In such a case, it is possible that the movable furniture part may collide with the room wall or with a movable furniture part of an adjacent furniture carcass, so that a movement of the movable furniture part is impeded or even made impossible.

### SUMMARY OF THE INVENTION

It is an object of the present invention to propose a furniture fitting of the type mentioned in the introductory part, thereby avoiding the drawbacks as discussed above.

According to the invention, the first fitting portion includes a housing having a front face facing towards the second fitting portion, and at least one housing side extending transversely to the front face. At least one arm is provided on which the at least one hinge axis is arranged, and the at least one arm projects transversely from the housing side of the first fitting portion.

In other words, the first fitting portion of the fitting is configured to be integrated into a stationary structure, in particular to be received within a wall thickness of a furniture panel. The at least one hinge axis for pivotally supporting the second fitting portion is laterally spaced apart from a plane formed by the housing side due to an arm projecting transversely from the lateral housing side of the housing.

In this way, the at least one hinge axis, in a mounted condition of the fitting, can be arranged further apart in a direction towards the middle of the furniture carcass. As a result, the furniture part connected to the second fitting portion no longer collides with an adjacent room wall or with a movable furniture part of an adjacent furniture carcass.

### BRIEF DESCRIPTION OF THE DRAWINGS

Further details and advantages of the present invention will be apparent from the following description with reference to the drawings, in which:

FIG. 1a, 1b show an item of furniture in a perspective view and an enlarged detail view thereof,

FIG. 2a, 2b show a stationary structure in the form of a furniture carcass in a perspective view and an enlarged detail view thereof,

FIG. 3a, 3b show the fitting in a perspective view and in a side view,

FIG. 4a, 4b show the fitting in two different perspective views,

FIG. 5a-5c show three different application possibilities of the fitting,

FIG. 6a-6c show two different items of furniture in different views.

### DETAILED DESCRIPTION OF THE INVENTION

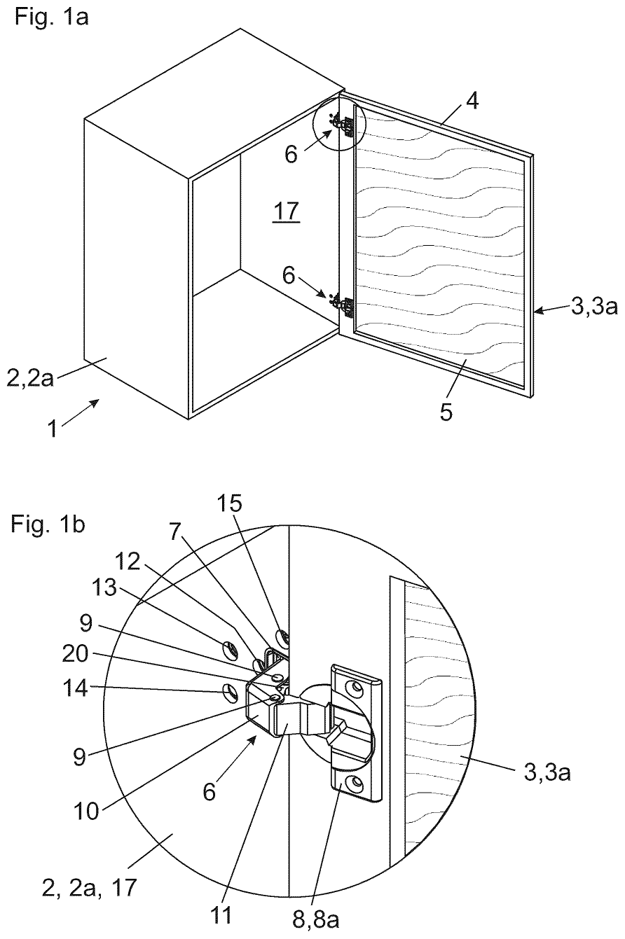

FIG. 1a shows a perspective view of an item of furniture 1 comprising a stationary structure 2, in particular a furniture carcass 2a, in which a pivoting element 3, in particular a movable furniture part 3a, is movably supported relative to the stationary structure 2 via two or more fittings 6.

In the shown embodiment, the pivoting element 3 includes a frame 4 and a, preferably transparent or translucent, decorative panel 5 arranged in the frame 4.

FIG. 1b shows the encircled region of FIG. 1a in an enlarged view. The fitting 6 includes a first fitting portion 7 configured to be fixed to the stationary structure 2, and a second fitting portion 8 configured to be fixed to the pivoting element 3. The first fitting portion 7 and the second fitting portion 8 are pivotally connected to each other via at least one hinge axis 9.

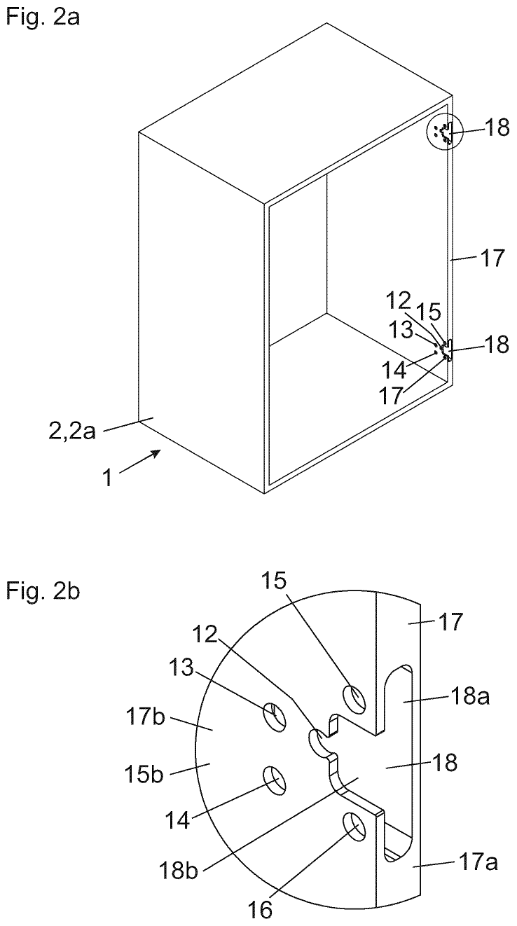

The first fitting portion 7 of the fitting 6 is configured to be at least partially countersunk in a recess 18 (FIG. 2a, 2b) in the stationary structure 2, for example in a panel 17 of the furniture carcass 2a, the panel 17 extending vertically in a mounted condition. The first fitting portion 7, in a mounted condition of the fitting 6, is substantially entirely integrated into the panel 17 of the furniture carcass 2a.

For example, the panel 17 can be a, preferably laminated, chipboard panel, a MDF-panel or a panel made of a different wood material which, in the present-day furniture construction, has a typical panel thickness of 16 mm. Moreover, also panels 17 with a different wall thickness, for example with 19 mm thickness, can be employed.

In order to prevent a collision of the pivoting element 3 with an adjacent room wall or with an adjacent pivoting element, the fitting 6 includes a lateral, transversely projecting arm 10 on which the at least one hinge axis 9 for pivotally supporting the second fitting portion 8 is arranged. The pivoting element 3, in a fully opened condition, is arranged in a plane extending substantially parallel and offset to the plane of the panel 17.

In the shown embodiment, the fitting 6 includes at least two hinge axes 9 arranged on the arm 10, and the first fitting portion 7 and the second fitting portion 8 are pivotally connected to each other via at least two hinge levers 11, 20.

For example, the second fitting portion 8 can include a hinge cup 8a arranged at least partially within a, preferably cylindrical, bore of the pivoting element 3. The bore can be arranged in a side face of the pivoting element 3, in particular in a side face of the frame 4.

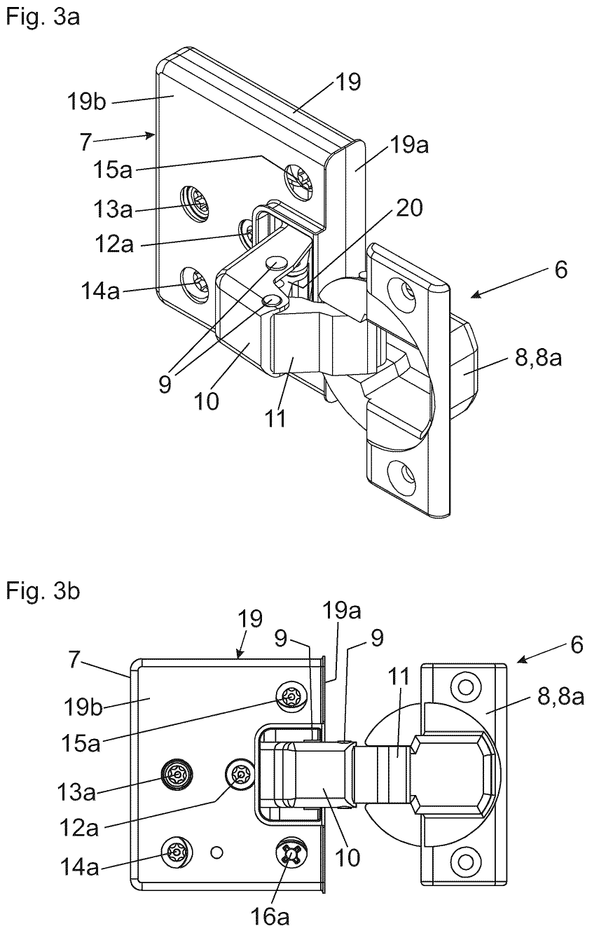

The panel 17 can include at least one opening 12, 13, 14, preferably a plurality of openings 12, 13, 14. The at least one opening 12, 13, 14 permits access to at least one adjustment device 12a, 13a, 14a (FIG. 3a, 3b) of the fitting 6.

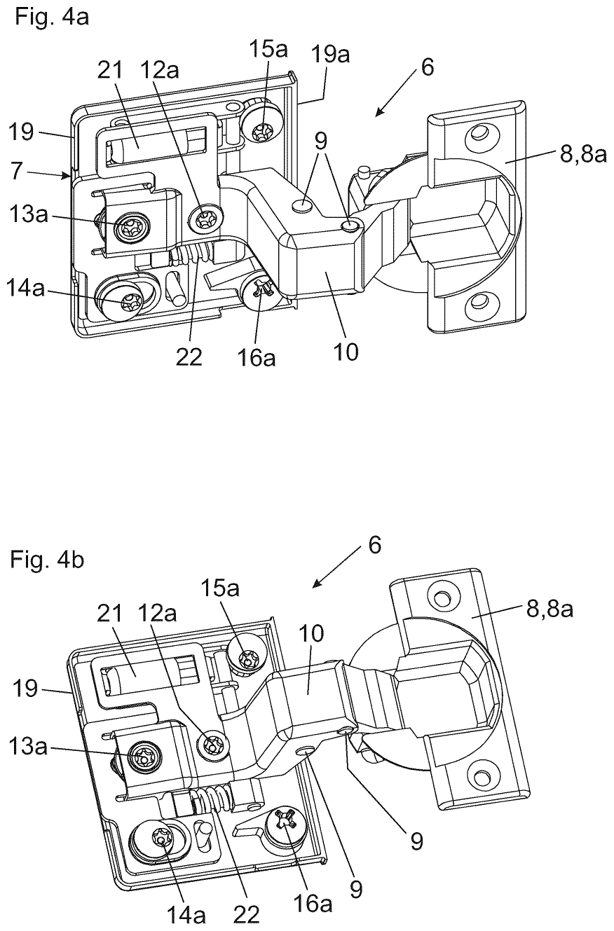

The panel 17 can include at least one further opening 15 which permits access to a movable switch element 15a (FIG. 3a, 3b) of the fitting 6. By the switch element 15a, a damping function of a damping device 21 (FIG. 4a, 4b) of the fitting 6 can be deactivated or limited.

FIG. 2a shows the stationary structure 2 in the form of the furniture carcass 2a in a perspective view. The pivoting element 3 and the fittings 6 for pivotally supporting the pivoting element 3 are not depicted.

The first fitting portion 7 of the fitting 6 is configured to be at least partially, preferably substantially entirely, received within a pocket-shaped recess 18 of the panel 17.

FIG. 2b shows the encircled region of FIG. 2a in an enlarged view. The pocket-shaped recess 18 includes an opening 18a, 18b arranged on a front face 17a of the panel 17 and on a side face 17b of the panel 17, the side face 17b of the panel 17 extending transversely to the front face 17a. Preferably, the two openings 18a, 18b are connected to each other such that the two openings 18a, 18b collectively form a common opening 18a, 18b.

The housing 19 of the first fitting portion 7 is configured to be inserted from the narrow front face 17a of the panel 17 into the pocket-shaped recess 18 of the panel 17. The panel 17 can include two or more openings 12, 13, 14 each permitting access to an adjustment device 12a, 13a, 14a (FIG. 3a, 3b) of the fitting 6. The panel 17 can include at least one further opening 15 which permits access to a movable switch element 15a (FIG. 3a, 3b) of the fitting 6. By the switch element 15a, a damping function of a damping device 21 (FIG. 4a, 4b) of the fitting 6 can be deactivated or limited. The panel 17 can include at least one further opening 16 which permits access to a fastening element 16a (FIG. 3b) of the fitting 6. By the fastening element 16a, the first fitting portion 7 is fixable in or to the panel 17.

At least one cover (not shown here) can be provided, and at least one opening 12, 13, 14, 15, 16, 18b of the panel 17, preferably an entirety of the openings 12, 13, 14, 15, 16, 18b of the panel 17, can be covered by the at least one cover. The at least one cover can be fixed to at least one of the openings 12, 13, 14, 15, 16, 18b.

FIG. 3a shows the fitting 6 in a perspective view. The first fitting portion 7 includes a housing 19 configured to be integrated into the panel 17. The housing 19 of the first fitting portion 7 includes a front face 19a facing towards the second fitting portion 8, and further includes at least one housing side 19b extending transversely to the front face 19a. At least one arm 10 is provided on which the at least one hinge axis 9 is arranged. The at least one arm 10 projects transversely from the housing side 19b of the first fitting portion 7.

According to an embodiment, the housing side 19b of the housing 19, from which the at least one arm 10 projects transversely, is substantially flat and/or is aligned substantially parallel to the panel 17 in a mounted condition on or in the panel 17. In a mounted condition, the at least one arm 10 projects transversely from the side face 17b (FIG. 2b) of the panel 17. The arm 10 can be substantially L-shaped and/or can be arranged so as to be stationary upon a relative movement of the two fitting portions 7, 8 to each other.

The housing side 19b of the housing 19, from which the at least one arm 10 projects transversely, extends substantially parallel to the panel 17. Preferably, the front face 19a of the housing 19 is configured substantially closed. Therefore, the ingress of dirt into the housing 19 of the first fitting portion 7 can be prevented, and a front face 19a arranged flush with the front face 17a (FIG. 2b) of the panel 17 can be provided. The housing 19 of the first fitting portion 7 can be substantially cuboidal and/or can extend substantially in plane extending parallel to the hinge axis 9.

In the shown embodiment, two hinge levers 11, 20 are provided which are arranged on the hinge axes 9 on the one hand and on the second fitting portion 8 on the other hand.

The first fitting portion 7 of the fitting 6 can include at least one adjustment device 12a, 13a, 14a having a movable adjustment element for adjusting a position of the arm 10 relative to the housing 19.

FIG. 3b shows the fitting 6 according to FIG. 3a in a side view. The housing side 19b includes at least one, preferably circular, opening which permits access to the at least one adjustment element of the adjustment device 12a, 13a, 14a, and/or the at least one adjustment element of the adjustment device 12a, 13a, 14a is at least partially arranged in the at least one opening of the housing side 19b. Each of the adjustment devices 12a, 13a, 14a includes a rotatable adjustment element, and a position of the arm 10 relative to the housing 19 is adjustable by rotating the adjustment element with the aid of a screwdriver.

Preferably, at least two, preferably three, adjustment devices 12a, 13a, 14a are provided. By the first adjustment device 12a, a position of the arm 10 relative to the housing 19 is adjustable in a first movement direction. By a second adjustment device 13a, 14a, a position of the arm 10 relative to the housing 19 is adjustable in a second movement direction, the second movement direction extending transversely to the first movement direction.

According to an embodiment, a position of the arm 10 relative to the housing 19 is adjustable by the adjustment device 12a in a lateral direction. By the adjustment device 13a, a position of the arm 10 relative to the housing 19 is adjustable in a depth direction. By the adjustment device 14a, a position of the arm 10 relative to the housing 19 is adjustable in a height direction.

The first fitting portion 7 can include at least one damping device 21 (FIG. 4a, 4b) for dampening a relative movement of the two fitting portions 7, 8 to each other. The housing side 19b of the housing 19 can include at least one further opening which permits access to a switch element 15a configured to deactivate or configured to limit a damping function of the damping device 21. Preferably, the switch element 15a is pivotally supported, and the damping function of the damping device 21 can be deactivated or can be limited by rotating the switch element 15a with the aid of a screwdriver.

The first fitting portion 7 can include at least one fastening element 16a configured to fix the first fitting portion 7 to or in the stationary structure 2. For this purpose, the housing side 19b includes a further, preferably circular, opening which permits access to the fastening element 16a, and/or the at least one fastening element 16a is arranged at least partially in the at least one further opening. Preferably, the fastening element 16a is rotationally supported, and the first fitting portion 7 can be fixed to or in the stationary structure 2 by rotating the fastening element 16a with the aid of a screwdriver.

FIG. 4a shows the fitting 6 with the two fitting portions 7, 8 in a perspective view. The first fitting portion 7 includes at least one damping device 21 for dampening a relative movement of the two fitting portions 7, 8 to each other. The damping device 21 can include at least one, preferably hydraulic, piston-cylinder-unit. Instead of the piston-cylinder-unit, a rotational damper can also be employed.

Further, the first fitting portion 7 includes at least one force storage member 22, preferably a spring element. The two fitting portions 7, 8 are movable into a closed end position and/or into an open end position relative to each other by a force of the force storage member 22. FIG. 4b shows the fitting 6 according to FIG. 4a in a further perspective view.

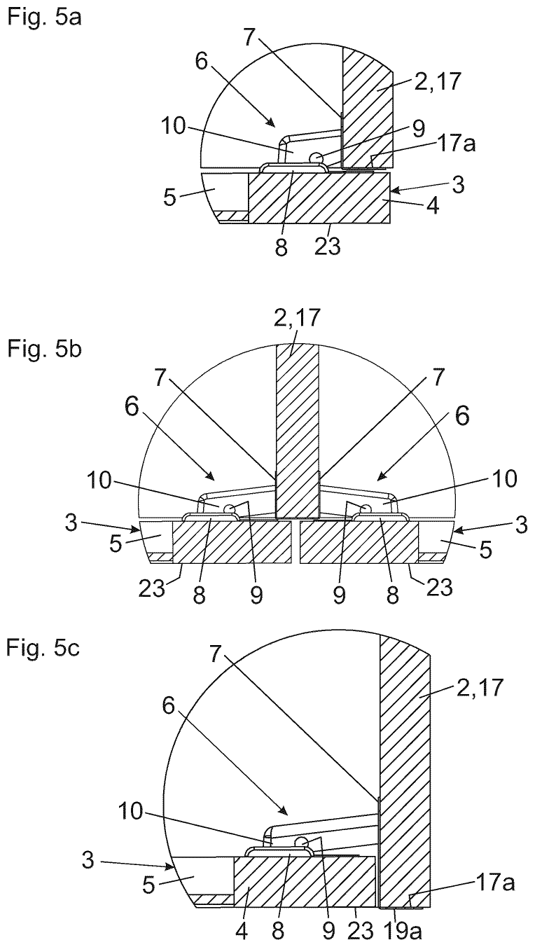

FIG. 5a shows a first application possibility of the fitting 6. The first fitting portion 7 is integrated into the stationary structure 2, preferably into the vertically extending panel 17 of the furniture carcass 2a. In contrast, the second fitting portion 8 is at least partially received within the pivoting element 3. The pivoting element 3, as shown in FIG. 1a and FIG. 1b, can include an outer frame 4 and a decorative panel 5, for example made of glass, arranged in the frame 4. In the shown embodiment, the second fitting portion 8 of the fitting 6 is at least partially received within the frame 4.

Due to the hinge axis 9 arranged on the arm 10, it is possible that the pivoting element 3 is unimpededly movable between a fully closed position and a fully open position, in particular when the panel 17 directly bears against an adjacent furniture carcass 2 or directly against a room wall. In the fully closed position, the pivoting element 3 covers at least partially, preferably substantially entirely, the front face 17a of the panel 17.

FIG. 5b shows a second application possibility of the fitting 6, in which two pivoting elements 3 are movably supported relative to the panel 17. A first fitting 6 is provided for supporting a first pivoting element 3, and a second fitting 6 is provided for supporting a second pivoting element 3. The first fitting portion 7 of one fitting 6 is integrated into a first side face of the panel 17, and the first fitting portion 7 of the other fitting 6 is integrated into a second side face of the panel 17. The two fittings 6 are mirror-symmetrically arranged to each other, and spaced apart from each other in a vertical direction in the plane of the panel 17. In the fully closed position, the two pivoting elements 3 at least partially cover, preferably in each case approximately a half, of the front face 17a of the panel 17.

FIG. 5c shows a third application possibility of the fitting 6, in which the pivoting element 3 is aligned substantially coplanar to the front face 17a of the panel 3 in a fully closed position, and/or the front face 19a of the housing 19 is visible in a closed condition of the fitting 6. The front face 19a of the housing 19 extends substantially flush with the front face 17a of the panel 17, and the substantially closed front face 19a of the housing 19 is visible for an operator in a closed condition of the pivoting element 3.

It can be recognized that the laterally projecting arm 10 of the fitting 6, for each of the three different application possibilities according to FIGS. 5a-5c, can have a different length.

With all embodiments, a particular advantage lies in the fact that due to the cranked configuration of the arm 10, no machining of the pivoting element 3 on the visible side 23 is necessary. The visible side 23 of the pivoting element 3, preferably of the frame 4, can thus be free from dents or recesses.

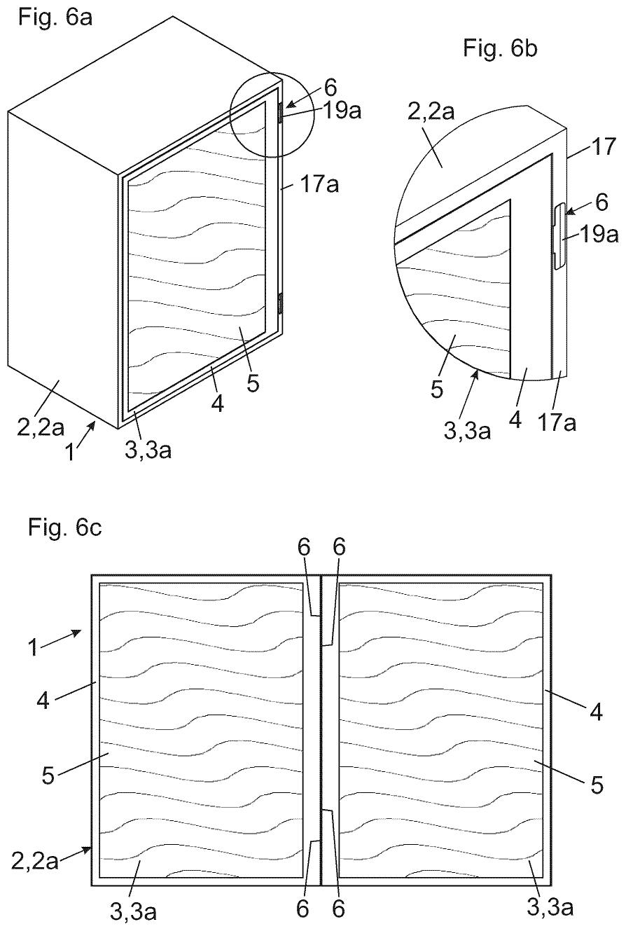

FIG. 6a shows a perspective view of an item of furniture 1 comprising a stationary structure 2 in the form of a furniture carcass 2a and a pivoting element 3 in the form of a movably supported furniture part 3a. The embodiment of the item of furniture 1 shown in FIG. 6a corresponds to the item of furniture 1 shown in FIG. 5c, in which an outer face of the pivoting element 3, in a closed condition of the pivoting element 3, is aligned substantially coplanar to the front face 17a of the panel 17.

FIG. 6b shows the encircled region of FIG. 6a in an enlarged view. It can be recognized that the front face 19a of the fitting 6 is closed and extends substantially flush with the front face 17a of the panel 17. In the closed condition of the pivoting element 3, the front face 19a of the fitting 6 is visible.

FIG. 6c shows an item of furniture 1 in a view from the front, in which the item of furniture 1 corresponds to the configuration according to FIG. 5b. The two pivoting elements 3 are pivotally supported on the vertically extending panel 17 via at least two fittings 6.

The first fitting portions 7 of the fittings 6 for supporting the first pivoting element 3 are integrated into a first side face of the panel 17, whereas the first fitting portions 7 of the fittings 6 for supporting the second pivoting element 3 are integrated into a second side face of the panel 17. The first fitting portions 7 for supporting the first pivoting element 3 and the first fitting portions 7 for supporting the second pivoting element 3 are arranged on the panel 7 so as to be spaced apart from each other in a height direction.

The shown and described fitting 6 is not only applicable for a furniture fitting for movably supporting a movably-supported furniture part 3a relative to a furniture carcass 2a, but also for a construction fitting for movably supporting a pivoting element 3 in the form of a window or a door.

1. A fitting configured as a furniture fitting or as a construction fitting for movably supporting a pivoting element relative to a stationary structure, in particular a furniture carcass, the fitting comprising:
a first fitting portion to be fixed to the stationary structure, the first fitting portion to be at least partially inserted into a recess in the stationary structure,
a second fitting portion to be fixed to a pivoting element, in particular to a movable furniture part, and
a hinge axis pivotally connecting the first fitting portion and the second fitting portion to each other,
wherein the first fitting portion includes a housing having a front face facing towards the second fitting portion, and at least one housing side extending transversely to the front face, and
wherein at least one arm is provided on which the at least one hinge axis is arranged, the at least one arm projecting transversely from the housing side of the first fitting portion.

2. The fitting according to claim 1, wherein the first fitting portion:
includes at least one adjustment device having a movable adjustment element for adjusting a position of the arm relative to the housing, preferably wherein the housing side of the housing includes at least one, preferably circular, opening which permits access to the at least one adjustment element of the adjustment device, and/or wherein the adjustment element of the at least one adjustment device is at least partially arranged in the opening of the housing side, and/or
includes at least one damping device for dampening a relative movement of the two fitting portions to each other, preferably wherein the housing side includes at least one, preferably circular, further opening which permits access to a switch element for deactivating or for limiting a damping function of the damping device, and/or
includes at least one fastening element for fixing the first fitting portion to or in the stationary structure, preferably wherein the housing side includes at least one, preferably circular, further opening which permits access to the fastening element, and/or wherein the at least one fastening element is at least partially arranged in the at least one further opening.

3. The fitting according to claim 1, wherein the first fitting portion includes at least two, preferably three, adjustment devices, wherein by a first adjustment device, a position of the arm relative to the housing is adjustable in a first movement direction, and wherein by a second adjustment device, a position of the arm relative to the housing is adjustable in a second movement direction, the second movement direction extending transversely to the first movement direction.

4. The fitting according to claim 1, wherein the housing of the first fitting portion:
is substantially cuboidal, and/or
extends substantially in a plane extending parallel to the hinge axis, and/or
is configured to be inserted from a narrow front face of a panel of the stationary structure into the recess of the panel.

5. The fitting according to claim 1, wherein the front face of the housing of the first fitting portion is substantially closed.

6. The fitting according to claim 1, wherein the arm:
is substantially L-shaped, and/or
is arranged so as to be stationary upon a relative movement of the two fitting portions to each other, and/or
projects transversely from a side face of a panel of the stationary structure in a mounted condition.

7. The fitting according to claim 1, wherein the first fitting portion includes at least one force storage member, preferably a spring element, wherein the two fitting portions are movable into a closed end position and/or into an open end position relative to each other by a force of the force storage member.

8. The fitting according to claim 1, wherein the second fitting portion:
includes at least one hinge cup, and/or
is hingedly connected to the arm of the first fitting portion via at least one hinge lever, preferably via at least two hinge levers.

9. The fitting according to claim 1, wherein the housing side of the housing, from which the at least one arm projects transversely, is substantially flat and/or is aligned substantially parallel to the plate in a mounted condition on or in the plate of the stationary structure.

10. An arrangement comprising:
a stationary structure, in particular a furniture carcass, and
the fitting according to claim 1,
wherein the stationary structure includes at least one vertically extending panel, and the housing of the first fitting portion is at least partially, preferably substantially entirely, received within a, preferably pocket-shaped, recess of the panel.

11. The arrangement according to claim 10, wherein the housing side of the housing, from which the at least one arm projects transversely, extends substantially parallel to the panel.

12. The arrangement according to claim 10, wherein the recess includes an opening arranged on a front face of the panel and on a side face of the panel, the side face of the panel extending transversely to the front face, preferably wherein the two openings are connected to each other such that the two openings collectively form a common opening.

13. The arrangement according to claim 10, wherein the first fitting portion:
includes at least one adjustment device having a movable adjustment element for adjusting a position of the arm relative to the housing, wherein the panel includes at least one, preferably circular, opening which permits access to the adjustment element of the at least one adjustment device, and/or
includes at least one damping device for dampening a relative movement of the two fitting portions to each other, preferably wherein the panel includes at least one, preferably circular, further opening which permits access to a switch element for deactivating or for limiting a damping function of the damping device, and/or
includes at least one fastening element for fixing the first fitting portion to the panel, preferably wherein the panel includes at least one, preferably circular, further opening which permits access to the fastening element.

14. The arrangement according to claim 10, wherein the fitting is a first fitting, the arrangement further comprising a second fitting identical to the first fitting and arranged on the panel, wherein the first fitting and second fitting are arranged mirror-symmetrically to each other and are spaced apart from each other in a vertical direction in the plane of the panel.

15. The arrangement according to claim 10, wherein the pivoting element:
is aligned substantially coplanar to a front face of the panel in the closed position, and/or wherein the front face of the housing of the first fitting portion is visible in a closed condition of the fitting, or
covers at least partially or substantially entirely a front face of the panel in a fully closed position.

16. The arrangement according to claim 10, wherein the pivoting element:
is arranged substantially in a plane parallel to and offset with respect to a plane of the panel in a fully closed position, and/or
includes a frame and a, preferably transparent or translucent, decorative panel arranged in the frame, and/or
has a visible side in the fully closed position, the visible side being substantially free from dents or recesses.

17. The arrangement according to claim 10, wherein the second fitting portion is at least partially arranged within a, preferably cylindrical, bore of the pivoting element, preferably wherein the bore is arranged on a side face of the pivoting element.
